(19) United States
(12) Patent Application Publication
(10) Pub. No.: US 2015/0085480 A1
(43) Pub. Date: Mar. 26, 2015

(54) TUBE-IN-TUBE LED TUBE

(71) Applicant: DONGGUAN CITY SAIGANG DECORATION MATERIAL CO., LTD, GUANGDONG PROVINCE (CN)

(72) Inventor: Chaorong HUANG, GUANGDONG PROVINCE (CN)

(21) Appl. No.: 14/332,410

(22) Filed: Jul. 16, 2014

(30) Foreign Application Priority Data
Sep. 26, 2013 (CN) 201320594309.9

(51) Int. Cl. F21K 99/00

(52) U.S. Cl. CPC F21K 9/175; F21Y 2103/003
USPC 362/223

(57) ABSTRACT

The invention relates to a tube-in-tube LED tube, which comprises a tubular plastic lampshade, two caps connected to power supply is separately defined at the two ends of the tubular plastic lampshade, a LED lamp board is defined inside the tubular plastic lampshade sheathed with a glass tube and two ends of the glass tube is separately connected to the two caps. In case of the glass tube broken, the tubular plastic lampshade can still protect the LED lamp board from being damaged. By the way, the tube-in-tube LED tube has properties of high safety, uniform illumination, larger illumination range, simple structure, and easy to manufacture and maintenance. Also the LED lamp board is embedded into the slots in the inner wall of the tubular plastic lampshade, resulting in convenient and quickly installation, and material saving.

### BACKGROUND OF THE INVENTION

The present invention relates to lamps and, in particular, to a tube-in-tube LED tube.

Lamps are widely used in different objects, such as in homes, offices and industry, and they are necessary in our daily life. The traditional fluorescent lamps are filled with phosphor containing heave metals, that may pollute the environment and cause great harm to the human body in the manufacturing process and use. In addition, the fluorescent lamps can not meet human's requirement because of their large power consumption and short service life. It is a good idea to replace the fluorescent lamps with LED tubes having energy saving, environmental protection and long service life.

LED component is a point light source, a number of the LED components are normally mounted on a circuit board to form luminous strip for lighting in the use of the process to achieve the luminous effect enough, but the light irradiated out is not uniform, easy to dizziness causing visual fatigue.

China patent 201220486312.4 discloses a model of LED glass tube, the LED glass tube with irregular circular cross section opens a notch in the inner wall of the tube, the notch is used to install a LED lamp board, the light irradiated out is not uniform and easy to dizziness.

China patent 201220090237.X discloses a model of LED glass tube, a semicircular plastic lampshade is defined in the LED glass tube, a LED lamp board and the semicircular plastic lampshade are separately connected with the LED glass tube, the connections must be through special processing, and the connection structures are unsafe, the range of the light irradiated out is relatively narrow.

### BRIEF SUMMARY OF THE INVENTION

An object of the invention is thus to provide a tube-in-tube LED tube so as to enable the aforementioned drawbacks to be solved. The tube-in-tube LED tube has properties of good insulation, high safety, uniform illumination, larger illumination range, simple structure, and easy to manufacture and maintenance.

An aspect of the invention is a tube-in-tube LED tube comprising a tubular plastic lampshade, two caps connected to power supply being separately defined at the two ends of the tubular plastic lampshade, a LED lamp board is defined inside the tubular plastic lampshade sheathed with a glass tube and two ends of the glass tube being separately connected to the two caps.

A gap of 1 mm is formed between the tubular plastic lampshade and the glass tube. The outer diameter of the glass tube is 26 mm and the thickness of the glass tube is 1 mm. The outer diameter of the tubular plastic lampshade is 22 mm and the thickness of the tubular plastic lampshade is 1 mm. The width of the LED lamp board is 11mm and the thickness of the LED lamp board is 1.2 mm. A plurality of LED lamp beads are well distributed on the LED lamp board.

Compared with the prior art, the present invention has advantages of:

a tubular plastic lampshade is sheathed with a glass tube and a LED lamp board is defined inside the tubular plastic lampshade, so that the tube-in-tube LED tube has properties of good insulation. In case of the glass tube broken, the tubular plastic lampshade can still protect the LED lamp board from being damaged. By the way, the tube-in-tube LED tube has properties of high safety, uniform illumination, larger illumination range, simple structure, and easy to manufacture and maintenance. Also the LED lamp board is embedded into the slots in the inner wall of the tubular plastic lampshade, resulting in convenient and quickly installation, and material saving.

### BRIEF DESCRIPTION OF THE DRAWINGS

FIG. 1 is a schematic diagram of the three-dimensional structure of a tube-in-tube LED tube according to the invention;

FIG. 2 is a cross-section view of a tube-in-tube LED tube structure according to a first embodiment of the invention;

FIG. 3 is a cross-section view of a tube-in-tube LED tube structure according to a second embodiment of the invention.

### DETAILED DESCRIPTION OF THE INVENTION

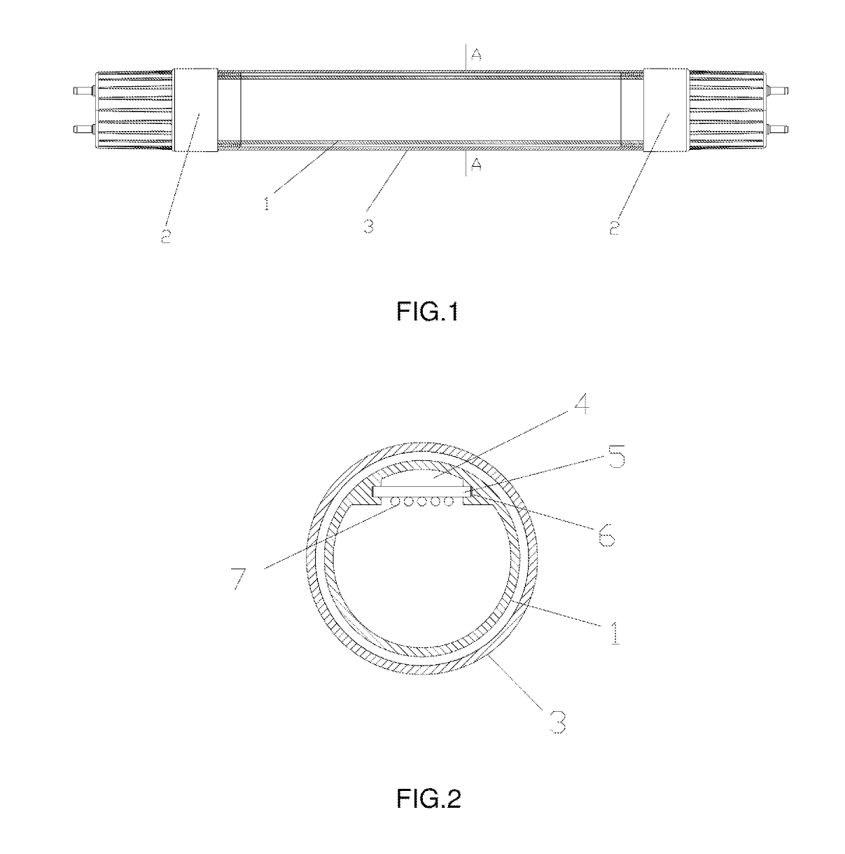

FIG. 1 and FIG. 2 show a tube-in-tube LED tube in accordance with a first embodiment of the invention. The tube-in-tube LED tube comprises a tubular plastic lampshade 1, two caps 2 connected to power supply are separately defined at the two ends of the tubular plastic lampshade 1, the tubular plastic lampshade 1 is sheathed with a glass tube 3 and two ends of the glass. tube 3 are separately connected to the two caps 2. The tubular plastic lampshade 1 is an integral forming structure. Two symmetrical slots 6 are defined in the inner wall of the tubular plastic lampshade 1 longitudinally. Two side edges of LED lamp board 5 are separately inserted in the two slots 6. A gap 4 is formed between the bottom of LED lamp board 5 and the inner wall of the tubular plastic lampshade 1.

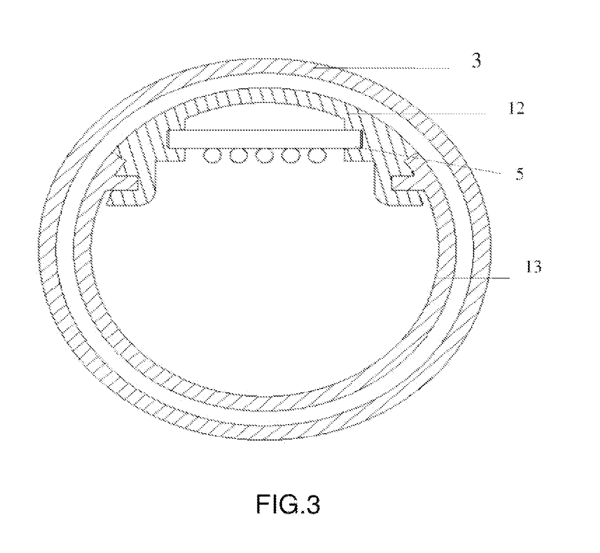

FIG. 3 shows a circular tubular plastic lampshade formed by an arc plastic parts 13 connected with an arc metal parts 12 by way of insertion in accordance with a second embodiment of the invention. Two symmetrical slots are defined in the inner wall of the arc metal parts 12 longitudinally. Two side edges of LED lamp board 5 are separately inserted in the two slots. A gap is formed between the bottom of LED lamp board 5 and the inner wall of the arc metal parts 12.

Wherein, the gap between the tubular plastic lampshade 1 and glass tube 3 is 1 mm. The gap can protect the LED lamp board from being damaged. In case of the glass tube broken, the tubular plastic lampshade can still protect the LED lamp board from being damaged and there is high safety for the LED lamp board.

In accordance with the embodiment of the invention some optimal values can be selected from as following: the outer diameter of the glass tube 3 is 26 mm and the thickness of the glass tube 3 is 1 mm; the outer diameter of the tubular plastic lampshade 1 is 22 mm and the thickness of the tubular plastic lampshade 1 is 1 mm; the width of the LED lamp board 5 is 11 mm and the thickness of the LED lamp board 5 is 1.2 mm. A plurality of LED lamp beads 7 are defined on the LED lamp board 5. Arranged LED lamp beads 7 are well-distributed so that there is a lighting effect of uniform illumination and wide illumination range.

It shall be noted that above-mentioned embodiments illustrate rather than limit the invention, and that those skilled in the art will be able to design many alternative embodiments without departing from the scope of the appended claims. In addition, although some specific terms used in this specification, but these terms are for convenience only, and does not constitute any limits to the invention.

What is claimed is:

1. A tube-in-tube LED tube comprising a tubular plastic lampshade, two caps connected to power supply being separately defined at the two ends of the tubular plastic lampshade, wherein a LED lamp board is defined inside the tubular plastic lampshade sheathed with a glass tube and two ends of the glass tube being separately connected to the two caps.

2. The tube-in-tube LED tube as claimed in claim 1, wherein the tubular plastic lampshade is an integral forming structure, two symmetrical slats are defined in the inner wail of the tubular plastic lampshade longitudinally; two side edges of the LED lamp board are separately inserted in the two slots.

3. The tube-in-tube LED tube as claimed in claim 1, wherein the tubular plastic lampshade is a circular tubular plastic lampshade formed by an arc plastic parts connected with an arc metal parts by way of insertion, two symmetrical slots are defined in the inner wall of the arc metal parts longitudinally, two side edges of the LED lamp board are separately inserted in the two slots.

4. The tube-in-tube LED tube as claimed in any of claims 1 to 3, wherein a gap is formed between the tubular plastic lampshade and the glass tube.

5. The tube-in-tube LED tube as claimed in any of claims 1 to 3, wherein a plurality of LED lamp beads are well distributed on the LED lamp board.
